(19) United States
(12) Patent Application Publication
(10) Pub. No.: US 2014/0081924 A1
(43) Pub. Date: Mar. 20, 2014

(54) IDENTIFICATION OF DATA OBJECTS STORED ON CLUSTERED LOGICAL DATA CONTAINERS

(71) Applicants: Logan R. Jennings, Menlo Park, CA (US); Zi-Bin Yang, San Francisco, CA (US)

(72) Inventors: Logan R. Jennings, Menlo Park, CA (US); Zi-Bin Yang, San Francisco, CA (US)

(73) Assignee: NetApp, Inc., Sunnyvale, CA (US)

(21) Appl. No.: 13/369,831

(22) Filed: Feb. 9, 2012

(51) Int. Cl. G06F 17/30

(52) U.S. Cl. 707/687; 707/E17.005

(57) ABSTRACT

Exemplary embodiments provide various techniques and systems for identifying data objects stored on clustered logical data containers. In one embodiment, a method is provided for creating a backward data object handle. In this method, a request to create a file is received, and a redirector file is created on a first logical data container based on receipt of the request. A redirector handle resulting from the creation of the redirector file is received. A data object of the file is then created on a second logical data container using the redirector handle as an identifier of the data object. This redirector handle included in the identifier then becomes a backward data object handle that points from the data object to the redirector file. As such, the redirector file can be identified by referencing the identifier of the data object.

### FIELD

The present disclosure relates generally to storage systems. In an example embodiment, the disclosure relates to the identification of data objects stored on clustered logical data containers.

### BACKGROUND

In a clustered storage system, data objects are not stored on one volume, but are distributed across multiple volumes. To track all these data objects, a layer of abstraction may be provided such that instead of directly referencing the data object itself, a reference is made to this abstraction layer, which stores information that points to a location of the data object stored on a particular volume.

As a result of this abstraction, data objects within a clustered storage system are generally not referenced by their name provided in a directory namespace. Instead, each data object is assigned a name that is only identifiable by the abstraction layer.

However, many applications (e.g., antivirus applications) that operate on a specific file system of a volume have access only to the abstracted names of the data objects. As a result, such applications cannot identify the actual names of the objects, as identified in the directory namespace, because only the abstraction layer recognizes the abstracted names. Without the actual name, many of these applications cannot communicate the identities of data objects to users.

### SUMMARY

Embodiments of the present invention provide various techniques to identify data objects stored on a system of clustered logical data containers. Generally, a pointer that points to a non-abstracted identifier of the data object is created and stored with the data object. As explained in detail below, it should be appreciated that a clustered storage system includes an additional layer of abstraction between directory entries and storage locations of stored data objects. This abstraction layer is particularly configured to store redirector files that point to various data objects stored on various logical data containers.

The pointer stored with the data object is in the form of a data object handle, which effectively points from the data object back to its corresponding redirector file. In one embodiment, this “backward” data object handle is used as an identifier of the data object.

As a result, an application that does not have access to this abstraction layer cannot identify a non-abstracted identifier of the data object as referenced by a user because that information is stored in the abstraction layer. However, with the creation of this backward data object handle, an application can follow this backward data object handle back to the abstraction layer to identify a data object's non-abstracted path name.

### BRIEF DESCRIPTION OF DRAWINGS

The present disclosure is illustrated by way of example and not limitation in the figures of the accompanying drawings, in which like references indicate similar elements and in which:

FIGS. 1 and 2 are block diagrams depicting, at different levels of detail, a network configuration in which the various embodiments of the present invention can be implemented;

FIG. 3 is a simplified architectural diagram of a storage server system, in accordance with an exemplary embodiment, for identifying data objects stored in clustered logical data containers;

FIG. 4 is a block diagram illustrating an overall architecture of a content repository embodied in a clustered storage server system, according to one exemplary embodiment;

FIG. 5 is a block diagram of an exemplary embodiment of a data object handle;

FIG. 6 is a block diagram depicting a system of logical data containers for referencing data objects stored in a cluster of logical data containers, in accordance with an exemplary embodiment of the present invention;

FIG. 7 is a block diagram depicting the referencing of data objects stored in a cluster of logical data containers;

FIG. 8 depicts a flow diagram of a general overview of a method 800, in accordance with an exemplary embodiment of the present invention, for creating a backward data object handle used to identify a data object;

FIG. 9 is a block diagram depicting the creation of backward data object handles;

FIG. 10 is an interaction diagram illustrating the interactions between different components to create a backward data object handle, in accordance with an exemplary embodiment of the present invention;

FIG. 11 depicts a flow diagram of a general overview of a method, in accordance with an exemplary embodiment of the present invention, for tracing back to a path of the redirector file from the data constituent volume; and

FIG. 12 depicts a hardware block diagram of a machine in the example form of a processing system within which may be executed a set of instructions for causing the machine to perform any one or more of the methodologies discussed herein.

### DESCRIPTION OF EXAMPLE EMBODIMENTS

The description that follows includes illustrative systems, methods, techniques, instruction sequences, and computing machine program products that embody the present invention. In the following description, for purposes of explanation, numerous specific details are set forth in order to provide an understanding of various embodiments of the inventive subject matter. It will be evident, however, to one skilled in the art that embodiments of the inventive subject matter may be practiced without these specific details. In general, well-known instruction instances, protocols, structures and techniques have not been shown in detail. Furthermore, the term “exemplary” is construed merely to mean an example of something or an exemplar and not necessarily a preferred or ideal means of accomplishing a goal.

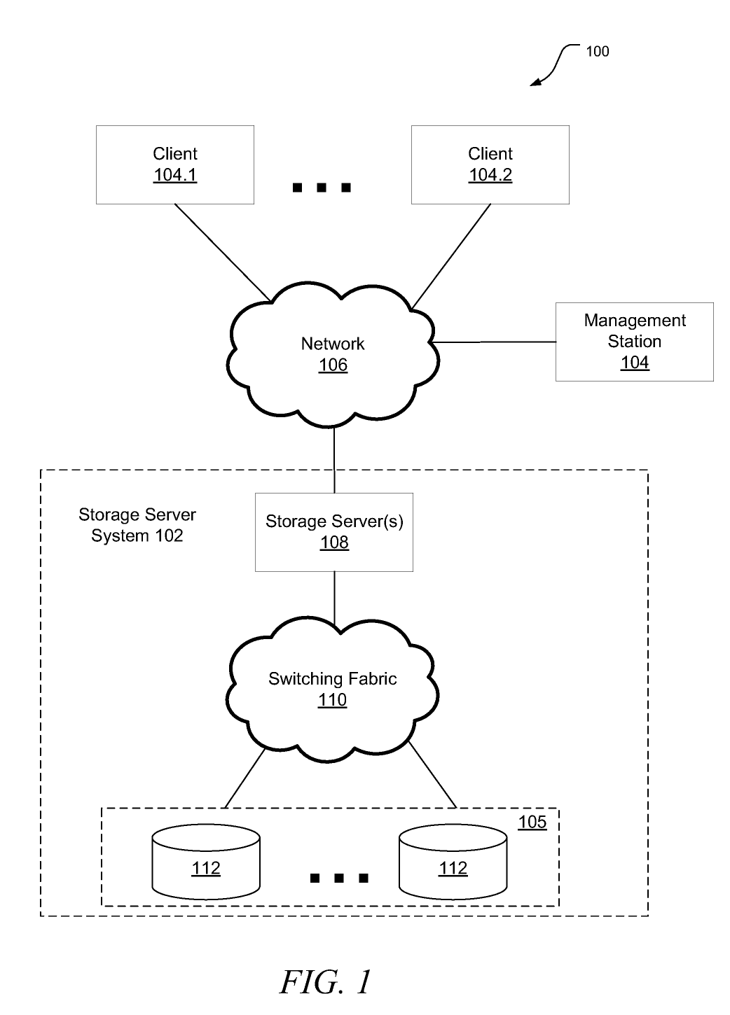

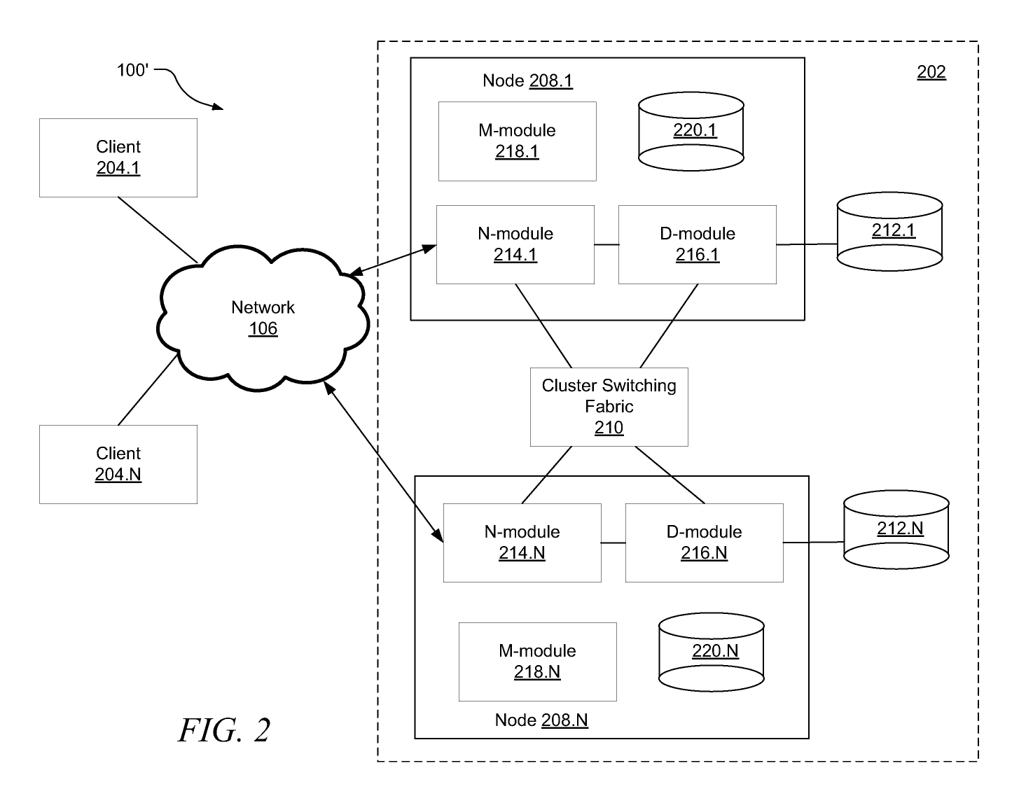

FIGS. 1 and 2 are block diagrams depicting, at different levels of detail, a network configuration in which the various embodiments of the present invention can be implemented. In particular, FIG. 1 is a block diagram depicting a network data storage environment 100, which includes client systems 104.1-104.2, a storage server system 102, and a computer network 106 connecting the client systems 104.1-104.2 and the storage server system 102. The storage server system 102 includes at least one storage server 108, a switching fabric 110, and a number of storage devices 112 in a mass storage subsystem 105. Examples of some or all of the storage devices 112 include hard drives, flash memories, solid-state drives (SSDs), tape storage, and other storage devices.

The storage server (or servers) 108 may be, for example, one of the FAS-xxx family of storage server products available from NETAPP, INC. located in Sunnyvale, Calif. The client systems 104.1-104.2 are connected to the storage server 108 via the computer network 106, which can be a packet-switched network, for example, a local area network (LAN) or wide area network (WAN). Further, the storage server 108 is connected to the storage devices 112 via a switching fabric 110, an example of which can be a fiber distributed data interface (FDDI) network. It is noted that, within the network data storage environment 100, any other suitable numbers of storage servers and/or storage devices, and/or any other suitable network technologies, may be employed. While FIG. 1 implies, in some embodiments, a fully connected switching fabric 110 where storage servers 100 can access all storage devices 112, it is understood that such a connected topology is not required. In some embodiments, the storage devices 112 can be directly connected to the storage servers 108.

The storage server 108 can make some or all of the storage space on the storage devices 112 available to the client systems 104.1-104.2. For example, each storage device 112 can be implemented as an individual disk, multiple disks (e.g., a RAID group) or any other suitable mass storage device(s). The storage server 108 can communicate with the client systems 104.1-104.2 according to well-known protocols, such as the Network File System (NFS) protocol or the Common Internet File System (CIFS) protocol, to make data stored on the storage devices 112 available to users and/or application programs. The storage server 108 can present or export data stored on the storage devices 112 as logical data containers to each of the client systems 104.1-104.2. As used herein, a “logical data container” is an abstraction of physical storage, combining one or more physical storage devices or parts thereof into a single logical storage object, and which is managed as a single administrative unit, such as a single file system. A volume and a logical unit, which is identifiable by logical unit number (LUN), are examples of logical data containers. A “file system” is a structured (e.g., hierarchical) set of stored logical data containers (e.g., volumes, LUNs, directories, data objects (e.g., files)). As illustrated below, it should be appreciated that a “file system” does not have to include or be based on “files” per se as its units of data storage.

In addition, various functions and configuration settings of the storage server 108 and the mass storage subsystem 105 can be controlled from a management station 106 coupled to the network 106. Among many other operations, operations related to identification of data objects stored on clustered logical data containers can be initiated from the management station 104.

FIG. 2 is a block diagram depicting a more detailed view of the network data storage environment 100 described in FIG. 1. The network data storage environment 100′ includes a plurality of client systems 204 (204.1-204.N), a clustered storage server system 202, and a computer network 106 connecting the client systems 204 and the clustered storage server system 202. As depicted, the clustered storage server system 202 includes server nodes 208 (208.1-208.N), a cluster switching fabric 210, and storage devices 212 (212.1-212.N).

Each of the nodes 208 can be configured to include several modules, including a networking module (“N-module”) 214, a data module (“D-module”) 216, a management module (“M-module”) 218 (each of which can be implemented by using a separate software module), and an instance of a replicated database (RDB) 220. Specifically, node 208.1 includes an N-module 214.1, a D-module 216.1, and an M-module 218.1. Node 208.N includes an N-module 214.N, a D-module 216.N, and an M-module 218.N. The N-modules 214.1-214.M include functionalities that enable nodes 208.1-208.N, respectively, to connect to one or more of the client systems 204 over the network 206. The D-modules 216.1-216.N provide access to the data stored on the storage devices 212.1-212.N, respectively. The M-modules 218 provide management functions for the clustered storage server system 202. Accordingly, each of the server nodes 208 in the clustered storage server arrangement provides the functionality of a storage server.

The RDB 220 is a database that is replicated throughout the cluster, (e.g., each node 208 includes an instance of the RDB 220). The various instances of the RDB 220 are updated regularly to bring them into synchronization with each other. The RDB 220 provides cluster-wide storage of various information used by all of the nodes 208, including a volume location database (VLDB) (not shown). The VLDB is a database that indicates the location within the cluster of each logical data container in the cluster (e.g., the owning D-module 216 for each volume), and is used by the N-modules 214 to identify the appropriate D-module 216 for any given logical data container to which access is requested.

The nodes 208 are interconnected by a cluster switching fabric 210, which can be embodied as a Gigabit Ethernet switch, for example. The N-modules 214 and D-modules 216 cooperate to provide a highly-scalable, distributed storage system architecture of a clustered computing environment implementing exemplary embodiments of the present invention. Note that while there is shown an equal number of N-modules 214 and D-modules 216 in FIG. 2, there may be differing numbers of N-modules 214 and/or D-modules 216 in accordance with various embodiments of the technique described herein. For example, there need not be a one-to-one correspondence between the N-modules 214 and D-modules 216. As such, the description of a node 208 comprising one N-module 214 and one D-module 216 should be understood to be illustrative only.

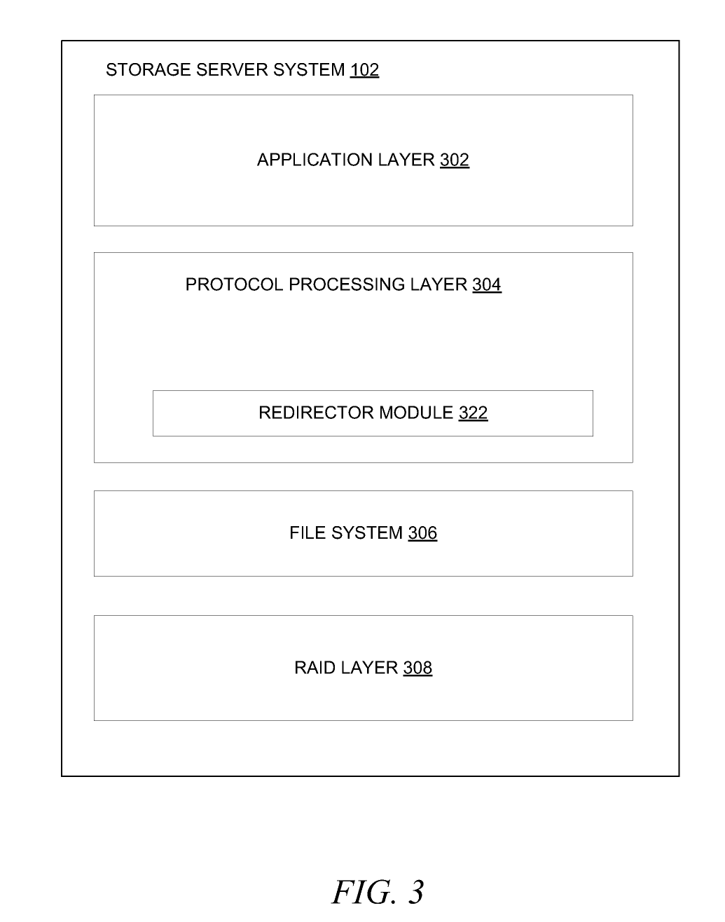

FIG. 3 is a simplified architectural diagram of a storage server system 102, in accordance with an exemplary embodiment, for identifying data objects stored in clustered logical data containers. The storage server system 102 supports a variety of layers 302, 304, 306, and 308 organized to form a multi-protocol engine that provides data paths for clients to access data stored in storage devices. The Redundant Array of Independent Disks (RAID) layer 308 provides the interface to RAID controllers, which distribute data over several storage devices. The file system layer (or file system) 306 forms an intermediate layer between storage devices and applications. It should be appreciated that storage devices are block-oriented storage medias and the file system 306 is configured to manage the blocks used by the storage devices. The file system 306 provides clients access to data objects organized in blocks by way of example directories and files.

The protocol processing layer 304 provides the protocols used to transmit stored data objects, such as Internet Small Computer System Interface (iSCSI), Network File System (NFS), and Common Internet File System (CIFS). In one exemplary embodiment, the protocol processing layer 304 includes a redirector module 322. As explained in detail below, the redirector module 322 is configured to provide indirection between directory entries and storage locations of stored data objects. Additionally included is an application layer 302 that interfaces to and performs common application services for application processes.

It should be appreciated that in other embodiments, the storage server system 102 may include fewer or more modules apart from those shown in FIG. 3. For example, in an alternate embodiment, the redirector module 322 can be further separated into two or more modules. The module 322 may be in the form of software that is processed by a processor. In another example, as explained in more detail below, the module 322 may be in the form of firmware that is processed by application specific integrated circuits (ASIC), which may be integrated into a circuit board. Alternatively, the module 322 may be in the form of one or more logic blocks included in a programmable logic device (for example, a field programmable gate array). The described module 322 may be adapted, and/or additional structures may be provided, to provide alternative or additional functionalities beyond those specifically discussed in reference to FIG. 3. Examples of such alternative or additional functionalities will be discussed in reference to the flow diagrams discussed below.

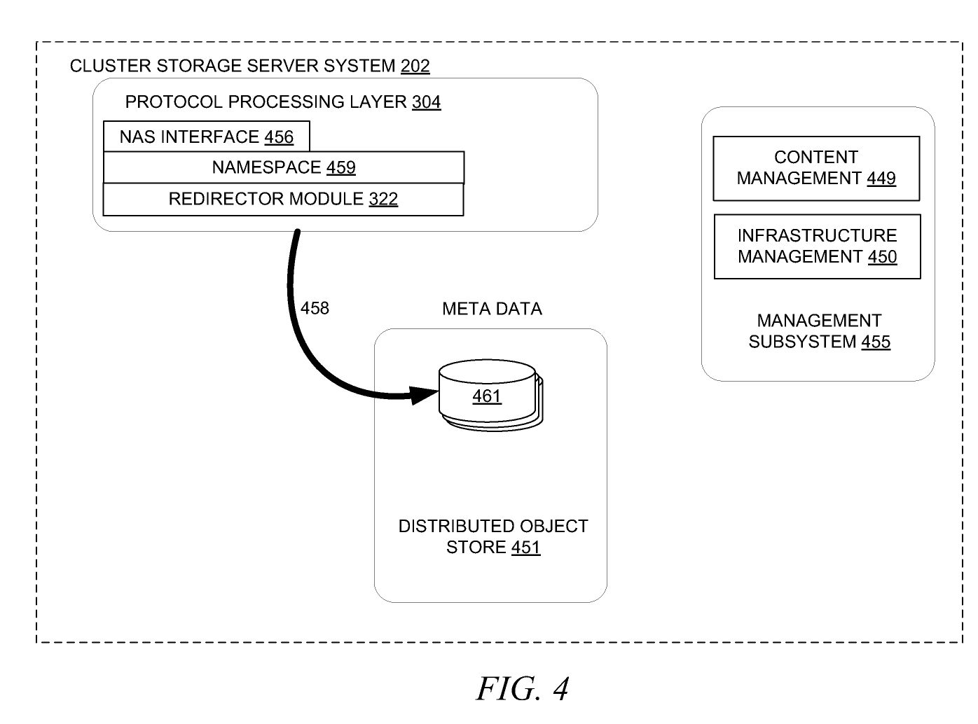

FIG. 4 is a block diagram illustrating an overall architecture of a content repository embodied in a clustered storage server system 202, according to one exemplary embodiment. Components of the content repository include a distributed object store 451, a protocol processing layer 304, and a management subsystem 455. A single instance of each of these components 451, and 304, can exist in the overall content repository, and each of these components 451, and 304 can be implemented in any one server node or distributed across two or more server nodes in a clustered storage server system 202.

The distributed object store 451 provides the actual data storage for all data objects in the clustered storage server system 202 and includes multiple distinct single-node object stores 461. A “single-node” object store is an object store that is implemented entirely within one node. Each single-node object includes a logical data container. Some or all of the single-node object stores 461 that make up the distributed object store 451 can be implemented in separate server nodes. Alternatively, all of the single-node object stores 461 that make up the distributed object store 451 can be implemented in the same server node. Any given server node can access multiple single-node object stores 461 and additionally, can itself include multiple single-node object stores 461.

The distributed object store 451 provides location-independent addressing of data objects with the ability to span the object address space across other similar systems spread over geographic distances. That is, data objects can be moved among single-node object stores 461 without changing the data objects' addressing. It should be noted that the distributed object store 451 has no namespace; the namespace for the clustered storage server system 202 is provided by the protocol processing layer 304.

The protocol processing layer 304 provides access 458 to the distributed object store 451 and essentially functions as a router, by receiving client requests, translating them into an internal protocol and sending them to the appropriate D-module. The protocol processing layer 304 provides two or more independent interfaces for accessing stored data (e.g., a conventional NAS interface 456). The NAS interface 456 allows access to the object store 451 via one or more conventional NAS protocols, such as NFS and/or CIFS. Thus, the NAS interface 456 provides a file system-like interface to the content repository. The NAS interface 456 allows access to data stored in the object store 451 by named object access, which uses a namespace 459. This namespace 459 is a file system-like directory-tree interface for accessing data objects. An example of a namespace 459 is a Portable Operating System Interface (POSIX) namespace.

The redirector module 322 in the protocol processing layer 304 generally provides a logical separation of directory entries and storage locations of stored data objects in the distributed object store 451. As described in detail below, the redirector module 322 can also provide the functionalities of identifying data objects stored on the distributed object store 451.

The management subsystem 455 includes a content management component 449 and an infrastructure management component 450. The infrastructure management component 450 includes logic to allow an administrative user to manage the storage infrastructure (e.g., configuration of nodes, disks, volumes, LUNs, etc.). The content management component 449 is a policy based data management subsystem for managing the lifecycle of data objects (and optionally the metadata) stored in the content repository, based on user-specified policies or policies derived from user-defined SLOs. It can execute actions to enforce defined policies in response to system-defined trigger events and/or user-defined trigger events (e.g., attempted creation, deletion, access, or migration of a data object). Trigger events do not have to be based on user actions. The specified policies may relate to, for example, system performance, data protection and data security. Performance related policies may relate to, for example, which logical container a given data object should be placed in, migrated from or to, when the data object should be migrated, deleted, or other file operations. Data protection policies may relate to, for example, data backup and/or data deletion. As used herein, a “policy” can be a set of specific rules regarding where to store what, when to migrate data, derived by the system from the end user's SLOs.

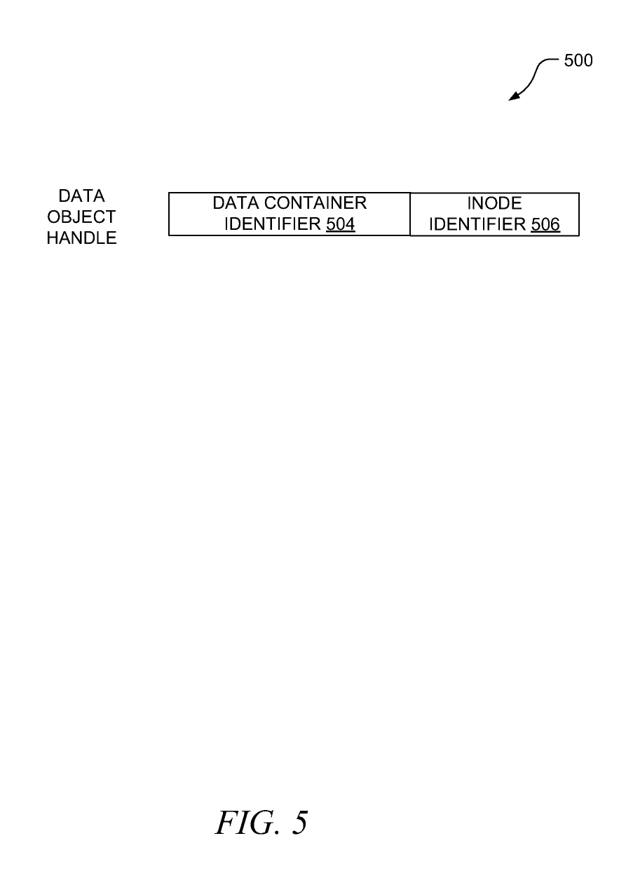

Access to the distributed object store is based on the use of a data object handle, an example of which is illustrated in FIG. 5. This exemplary data object handle 500 includes a logical data container identifier 504 and an inode identifier 506 on that data container. The logical data container identifier 504 is a value that uniquely identifies a logical data container. The inode is a data structure used to store the metadata of one or more data containers. The inode includes a set of pointers to blocks within a file system. For data objects, for example, the inode may directly point to blocks storing the data objects.

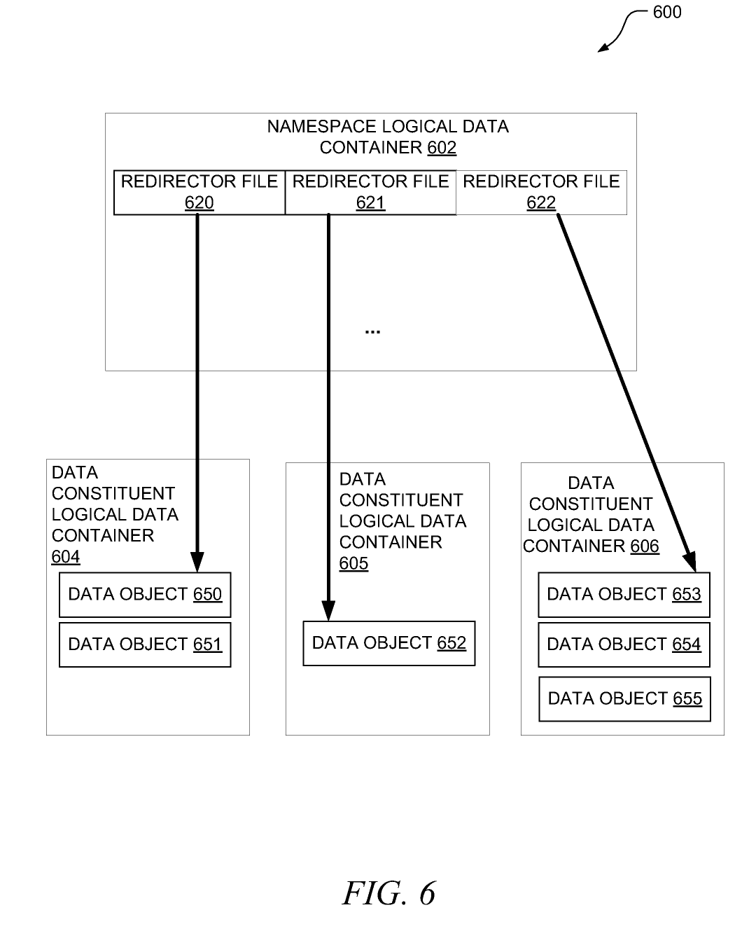

FIG. 6 is a block diagram depicting a system 600 of logical data containers 602 and 604-606 for referencing data objects stored in a cluster of logical data containers 604-606, in accordance with an exemplary embodiment of the present invention. The system 600 includes a logical data container 602 that is specifically configured to store data associated with a namespace. In other words, this logical data container 602 is not configured to store the actual data objects 650-655 being accessed by a client. As used herein, such a logical data container 602 is referred to as a “namespace logical data container.” The system 600 also includes logical data containers 604-606 that are specifically configured to store data objects. In other words, the logical data containers 604-606 are not configured to store namespace data. As used herein, such a logical data container 604, 605, or 606 is referred to as a “data constituent logical data container.”

Path names of data objects 650-655 in a storage server system are stored in association with a namespace (e.g., a directory namespace). The directory entry maintains a separate directory for each data object stored in a distributed object store. A directory entry, as indicated herein, refers to an entry that describes an identifier of any type of data object (e.g., directories, files, and logical data containers). An identifier refers to a value (numeric and/or textual) that uniquely identifies a data object. A name of a data object is an example of such an identifier. Each directory entry includes a path name of the data object and a pointer for mapping the directory entry to the data object. In a traditional storage system, the pointer (e.g., an inode number) directly maps the path name to an inode associated with the data object. On the other hand, in the illustrated embodiment shown in FIG. 6, the pointer of each data object points to a redirector file 620, 621, or 622 associated with a data object 650, 651, 652, 653, or 655. A “redirector file,” as indicated herein, refers to a file that maintains an object locator of the data object. The object locator of the data object can be a data object handle of the data object. In particular, from the perspective of a client, each data object handle points from the redirector file to a data object and thus, such a data object handle can be referred to as a “forward data object handle.” In addition to the object locator data, each redirector file 620, 621, or 622 may also contain other data about the data object, such as metadata about a location of the redirector file. In the illustrated embodiment, the redirector files 620-622 are stored within the namespace logical data container 602.

When a client attempts to read or write a data object, the client includes a reference to a redirector file 620, 621, or 622 of the data object in its read or write request to the storage server system. The storage server system references the redirector file 620, 621, or 622 to the exact location within a data constituent logical data container where the data object is stored. In the example depicted in FIG. 6, a data object handle in redirector file 620 points to a data object 650 stored on data constituent logical data container 604. The data object handle in redirector file 621 points to a data object 652 stored on data constituent logical data container 604. The data object handle in redirector file 622 points to a data object 653 stored on data constituent logical data container 606.

By having the directory entry pointer of a data object point to a redirector file 620, 621, or 622 instead of pointing to an actual inode of the data object, the storage server system introduces a layer of indirection between (or provides a logical separation of) directory entries and storage locations of the stored data object. This separation facilitates transparent migration (e.g., a data object can be moved without affecting its name), and moreover, it enables any particular data object to be represented by multiple path names, thereby facilitating navigation. In particular, this allows the implementation of a hierarchical protocol such as NFS on top of an object store, while at the same time allowing access via a flat object address space (wherein clients directly use the global object ID to access objects) and maintaining the ability to do transparent migration.

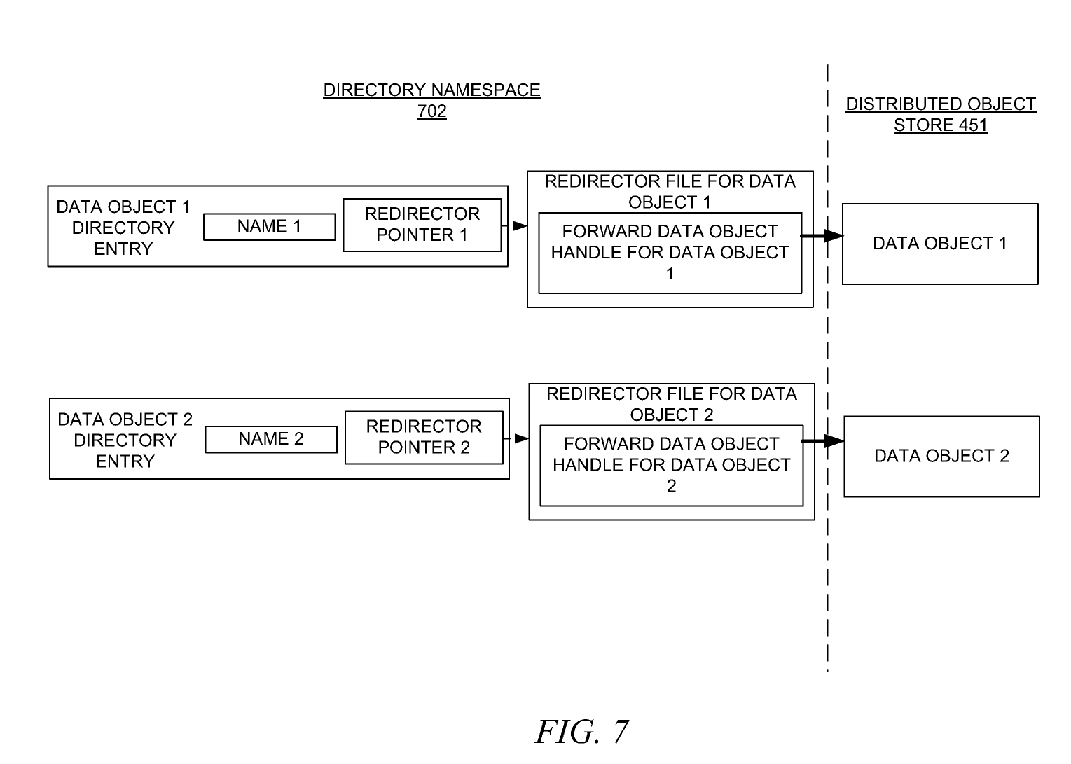

FIG. 7 is a block diagram depicting the referencing of data objects stored in a cluster of logical data containers. As illustrated, path names of data objects in the storage server system are stored in association with a namespace (e.g., a directory namespace 702). Here, each directory entry includes a path name (e.g., NAME 1 or NAME 2) of the data object and a pointer (e.g., REDIRECTOR POINTER 1 or REDIRECTOR POINTER 2) for mapping the directory entry to the data object.

The redirector pointer of each data object points to a redirector file associated with the data object. In the illustrated embodiment, the redirector files are stored within the directory namespace 702. The redirector file for data object 1 includes a forward data object handle that, from the perspective of a client, points to a specific location (e.g., a physical address) of the data object within the distributed object store 451. Similarly, the redirector file for data object 2 includes a forward data object handle. Accordingly, the server system 202 can map the directory entry of each data object to a specific location of the data object within the distributed object store. By using this mapping, a storage server system can mimic a traditional file system hierarchy, while also being able to provide location independence of directory entries.

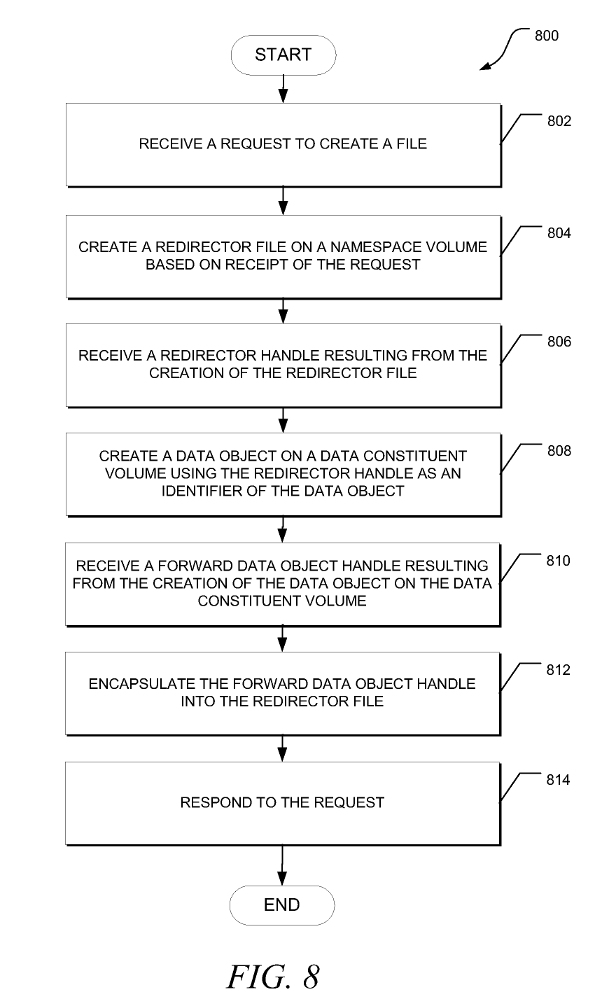

FIG. 8 depicts a flow diagram of a general overview of a method 800, in accordance with an exemplary embodiment of the present invention, for creating a backward data object handle used to identify a data object. In an exemplary embodiment, the method 800 may be implemented by the redirector module employed within a protocol processing layer, as discussed above.

As depicted in FIG. 8, the redirector module receives a request, at 802, from a client to create a file. Upon receipt of the request, the redirector module creates, at 804, a redirector file on a namespace logical data container. The creation of the redirector file results in the creation of a redirector handle, which is received by the redirector module at 806. The redirector handle is a data object handle that points to the redirector file.

The redirector module then creates, at 808, a data object on a data constituent logical data container using the previously received redirector handle as an identifier of the data object. In one embodiment, the redirector handle is a name of the data object. In an alternate embodiment, the name comprises, in part, the redirector handle along with other metadata. By using the redirector handle as an identifier of the data object, the redirector handle then becomes a “backward” data object handle that points from the data object stored on the data constituent logical data container back to the redirector file stored on the namespace logical data container. From the perspective of a client, the backward data object handle points to a direction (from data object to redirector file) that is opposite of the “forward” data object handle. Accordingly, an application having access to only the data constituent logical data container can locate the redirector file stored on the namespace logical data container by referencing the backward data object handle.

After the backward data object handle has been created, the redirector module then, at 810, receives a forward data object handle resulting from the creation of the data object on the data constituent logical data container. In other words, the creation of a data object on the data constituent logical data container also results in the generation of a forward data object handle, and this forward data object handle is provided to the redirector module. As discussed above, the forward data object handle points from the redirector file to the data object.

Still referring to FIG. 8, the redirector module then, at 812, encapsulates the forward data object handle into the redirector file. Encapsulation can include the attachment of the forward data object handle to the redirector file or including the forward data object handle as content of the redirector file. The redirector module then, at 814, responds to the client's initial request.

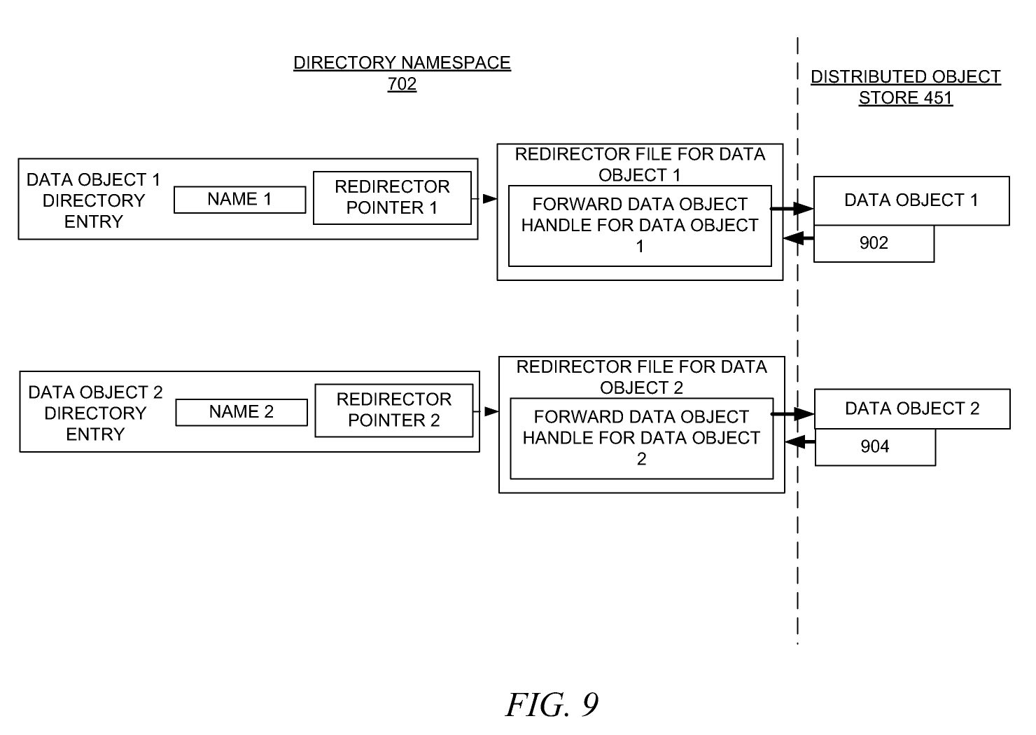

FIG. 9 is a block diagram depicting the creation of backward data object handles. It should be appreciated that FIG. 9 is nearly identical to FIG. 7 where, as previously described, each directory entry includes a path name (e.g., NAME 1 or NAME 2) of the data object and a pointer (e.g., REDIRECTOR POINTER 1 or REDIRECTOR POINTER 2) for mapping the directory entry to the data object. The redirector pointer of each data object points to a redirector file associated with the data object. In the illustrated embodiment, the redirector files are stored within the directory namespace 702. The redirector file for data object 1 includes a forward data object handle that, from the perspective of a client, points to a specific location (e.g., a physical address) of the data object within the distributed object store 451. Similarly the redirector file for data object 2 includes a forward data object handle. Accordingly, a server system can map the directory entry of each data object to a specific location of the data object within the distributed object store.

In addition, FIG. 9 also shows that names 902 and 904 assigned to the data objects 1 and 2 include backward data object handlers that point back to the redirector files for data objects 1 and 2, respectively. As explained in detail below, the paths of the redirector files in the directory namespace 702 can be identified by referencing the backward data object handlers.

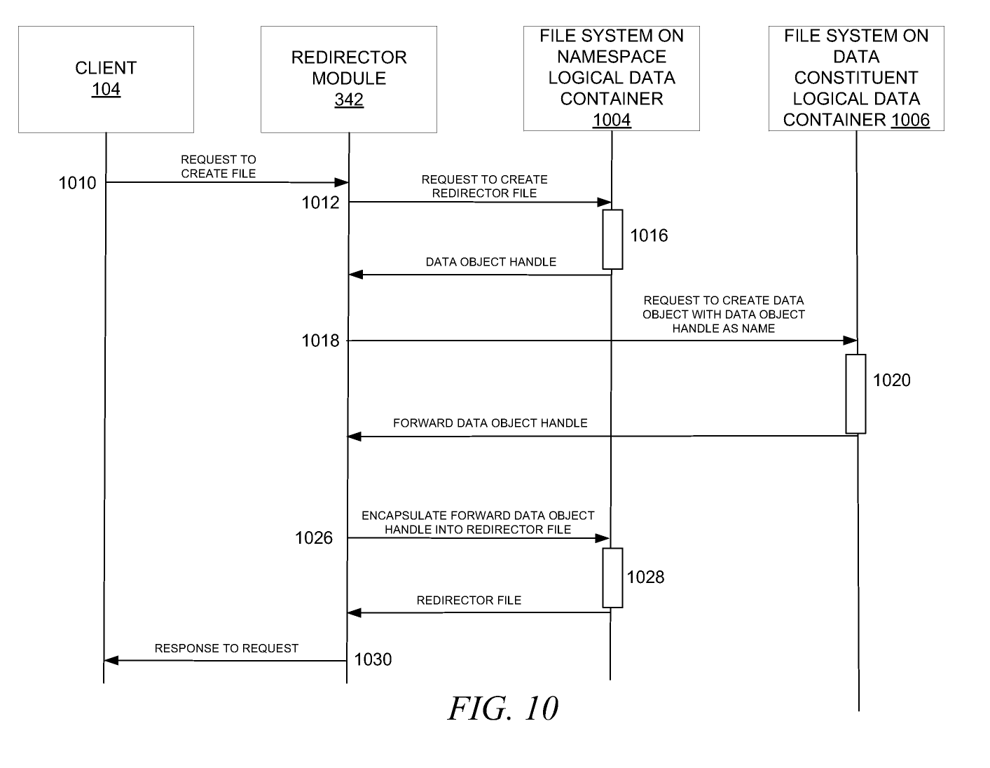

FIG. 10 is an interaction diagram illustrating the interactions between different components to create a backward data object handle, in accordance with an exemplary embodiment of the present invention. This diagram depicts a system that includes a client 104, a redirector module 342, a file system 1004 on a namespace volume, and another file system 1006 on a data constituent volume.

Starting at 1010, the client 104 transmits a request to the redirector module 342. This request is to create a file and upon receipt of the request, the redirector module 342 transmits, at 1012, a request to the file system 1004 to create a redirector file on the namespace volume.

At 1016, the file system 1004 creates the redirector file on the namespace volume, and in response to the creation of the redirector file, the file system 1004 also generates a redirector handle. In particular, upon receipt of the request, the file system 1004 assigns an inode number to a data object. The file system 1004 then creates a directory entry that points to this inode number and generates a redirector handle that is associated with the redirector file. This redirector handle points to the inode in the namespace system. This generated redirector handle is then returned to the redirector module 342.

After receipt of the redirector handle from the file system 1004, the redirector module 342, at 1018, transmits a request to the file system 1006 on the data constituent logical data container to create a data object associated with the redirector handle as its name. At 1020, the file system 1006, in turn, creates the data object on the data constituent logical data container using the received redirector handle as a name of the data object. As described above, in one embodiment, the redirector handle itself can be the complete name of the data object. In an alternate embodiment, the redirector handle can be a part of the name. When the redirector handle is used as a name of the data object, the redirector handle effectively becomes a backward data object handle that points back to the redirector file stored on the namespace logical data container.

As part of the creation of the data object, the file system 1006 also generates a forward data object handle at 1020. The file system 1006 then transmits the forward data object handle to the redirector module 342. Upon receipt of the forward data object handle, the redirector module 342, at 1026, transmits a request to the file system 1004 to encapsulate the forward data object handle into the redirector file. At 1028, the file system 1004 encapsulates the forward data object handle into the redirector file. As described above, the redirector file includes the forward data object handle as its content. The file system 1004 then returns the redirector file with the encapsulated forward data object handle to the redirector module 342. In turn, the redirector module 342 responds to the original request from the client 104 to create the file with the redirector file received from the file system 1004. By referencing the redirector file, the client 104 can locate the data object stored on the data constituent logical data container.

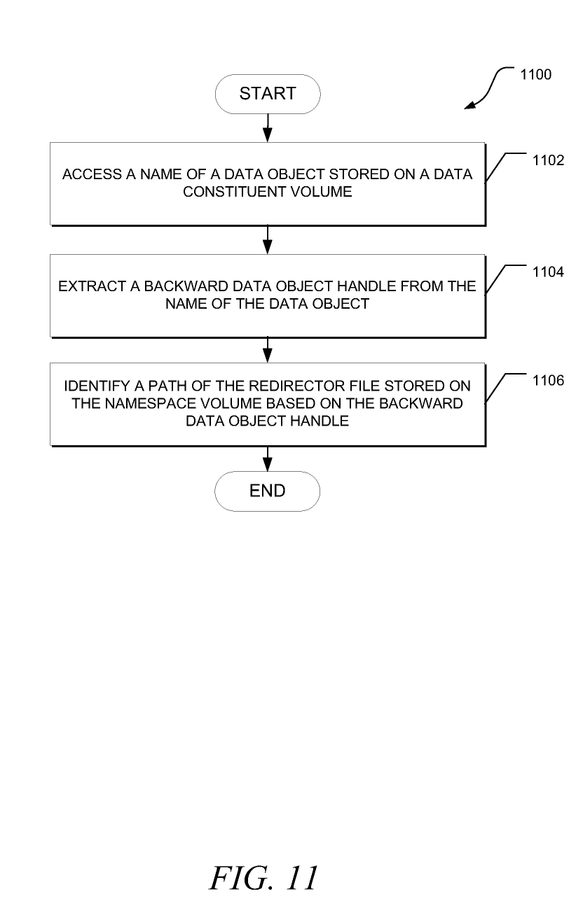

FIG. 11 depicts a flow diagram of a general overview of a method 1100, in accordance with an exemplary embodiment of the present invention, for tracing back to a path of a redirector file from the data constituent volume. In an exemplary embodiment, the method 1100 may be implemented by a variety of applications having access to only the data constituent logical data container. For example, in one embodiment, the content management component 449 described previously in FIG. 9 can implement the methodologies of method 1100. In another example, an antivirus application having access to only the data constituent logical data container can implement the methodologies of method 1100.

As depicted in FIG. 11, an application accessing the data constituent logical data container directly may want to identify a name of a data object as used by the client. However, the data constituent logical data container in a clustered storage system does not store such information. Accordingly, at 1102, the application accesses a name of a data object stored on this data constituent logical data container. The application then extracts a backward data object handle from this name at 1104. This extracted backward data object handle points from the data object stored on the data constituent logical data container to a redirector file stored on a namespace logical data container.

The backward data object handle can be extracted from the name by identifying a portion of the name that is reserved for the backward data object handle, and reading the backward data object handle from this portion of the name. At 1106, an application can then use the backward data object handle to identify a path of the redirector file that is stored on the namespace logical data container.

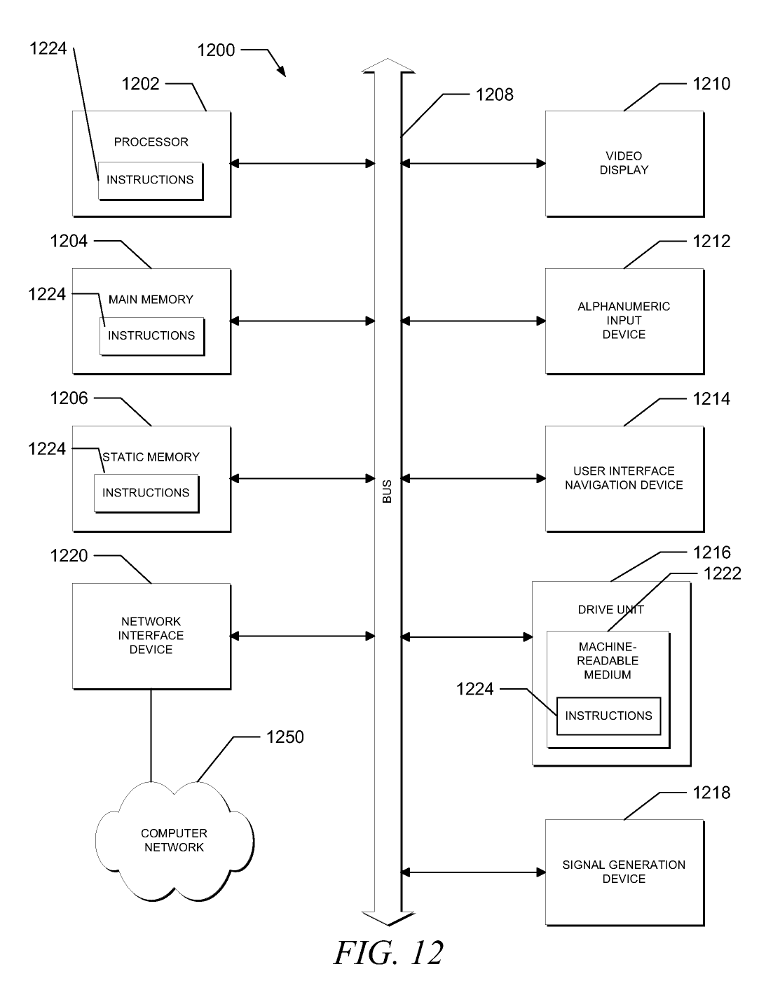

FIG. 12 depicts a hardware block diagram of a machine in the example form of a processing system 1200 (e.g., a storage server system) within which may be executed a set of instructions for causing the machine to perform any one or more of the methodologies discussed herein. In alternative embodiments, the machine operates as a standalone device or may be connected (e.g., networked) to other machines. In a networked deployment, the machine may operate in the capacity of a server or as a peer machine in a peer-to-peer (or distributed) network environment.

The machine is capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example of the processing system 1200 includes a processor 1202 (e.g., a central processing unit (CPU), a graphics processing unit (GPU) or both), a main memory 1204 (e.g., random access memory), and static memory 1206 (e.g., static random-access memory), which communicate with each other via bus 1208. The processing system 1200 may further include video display unit 1210 (e.g., a plasma display, a liquid crystal display (LCD) or a cathode ray tube (CRT)). The processing system 1200 also includes an alphanumeric input device 1212 (e.g., a keyboard), a user interface (UI) navigation device 1214 (e.g., a mouse), a disk drive unit 1216, a signal generation device 1218 (e.g., a speaker), and a network interface device 1220.

The disk drive unit 1216 (a type of non-volatile memory storage) includes a machine-readable medium 1222 on which is stored one or more sets of data structures and instructions 1224 (e.g., software) embodying or utilized by any one or more of the methodologies or functions described herein. The data structures and instructions 1224 may also reside, completely or at least partially, within the main memory 1204 and/or within the processor 1202 during execution thereof by processing system 1200, with the main memory 1204 and processor 1202 also constituting machine-readable, tangible media.

The data structures and instructions 1224 may further be transmitted or received over a computer network 3 via network interface device 1220 utilizing any one of a number of well-known transfer protocols (e.g., HyperText Transfer Protocol (HTTP)).

Certain embodiments are described herein as including logic or a number of components, modules, or mechanisms. Modules may constitute software modules (e.g., code embodied on a machine-readable medium or in a transmission signal) and/or hardware modules. A hardware module is a tangible unit capable of performing certain operations and may be configured or arranged in a certain manner. In example embodiments, one or more computer systems (e.g., the processing system 1200) or one or more hardware modules of a computer system (e.g., a processor 1202 or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor 1202 or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor 1202 configured using software, the general-purpose processor 1202 may be configured as respective different hardware modules at different times. Software may accordingly configure a processor 1202, for example, to constitute a particular hardware module at one instance of time and to constitute a different hardware module at a different instance of time.

Modules can provide information to, and receive information from, other modules. For example, the described modules may be regarded as being communicatively coupled. Where multiples of such hardware modules exist contemporaneously, communications may be achieved through signal transmission (e.g., over appropriate circuits and buses) that connect the modules. In embodiments in which multiple modules are configured or instantiated at different times, communications between such modules may be achieved, for example, through the storage and retrieval of information in memory structures to which the multiple modules have access. For example, one module may perform an operation, and store the output of that operation in a memory device to which it is communicatively coupled. A further module may then, at a later time, access the memory device to retrieve and process the stored output. Modules may also initiate communications with input or output devices, and can operate on a resource (e.g., a collection of information).

The various operations of example methods described herein may be performed, at least partially, by one or more processors 1202 that are temporarily configured (e.g., by software) or permanently configured to perform the relevant operations. Whether temporarily or permanently configured, such processors 1202 may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors 1202 or processor-implemented modules. The performance of certain of the operations may be distributed among the one or more processors 1202, not only residing within a single machine, but deployed across a number of machines. In some example embodiments, the processors 1202 may be located in a single location (e.g., within a home environment, an office environment or as a server farm), while in other embodiments the processors 1202 may be distributed across a number of locations.

While the embodiment(s) is (are) described with reference to various implementations and exploitations, it will be understood that these embodiments are illustrative and that the scope of the embodiment(s) is not limited to them. In general, techniques for identification of data objects may be implemented with facilities consistent with any hardware system or hardware systems defined herein. Many variations, modifications, additions, and improvements are possible.

Plural instances may be provided for components, operations or structures described herein as a single instance. Finally, boundaries between various components, operations, and data stores are somewhat arbitrary, and particular operations are illustrated in the context of specific illustrative configurations. Other allocations of functionality are envisioned and may fall within the scope of the embodiment(s). In general, structures and functionality presented as separate components in the exemplary configurations may be implemented as a combined structure or component. Similarly, structures and functionality presented as a single component may be implemented as separate components. These and other variations, modifications, additions, and improvements fall within the scope of the embodiment(s).

1. A method of creating a backward data object handle, the method comprising:
receiving, from over a network, a request from a client device to create a file;
creating a redirector file on a first logical data container in response to receiving the request;
receiving a redirector handle resulting from the creation of the redirector file;
creating a data object of the file on a second logical data container using the redirector handle as an identifier of the data object, wherein the redirector handle is a backward data object handle, from a perspective of the client device, that points from the data object on the second logical data container to the redirector file on the first logical data container, wherein the redirector file on the first logical data container is identified by referencing the identifier of the data object stored on the second logical data container;
receiving a forward data object handle resulting from the creation of the data object on the second logical data container, wherein the forward data object handle, from the perspective of the client device, points from the redirector file to the data object; and
encapsulating the forward data object handle into the redirector file so that the redirector file includes the forward data object handle.

2. The method of claim 1, further comprising:
responding to the request to create the file.

3. The method of claim 1, wherein the data object of the file can be located based on the redirector file.

4. The method of claim 1, wherein the identifier is a name of the data object.

5. The method of claim 4, wherein the name of the data object comprises the redirector handle.

6. The method of claim 1, wherein the first logical data container is a namespace logical data container that is configured to store redirector files.

7. The method of claim 1, wherein the first logical data container is a namespace logical data container that is not configured to store data objects.

8. The method of claim 1, wherein the second logical data container is a data constituent logical data container that is configured to store data objects.

9. A non-transitory, machine-readable medium that stores instructions that, when performed by a storage system, cause the storage system to perform operations comprising:
accessing an identifier of a data object stored on a first logical data container;
extracting a backward data object handle from the identifier, wherein the backward data object handle, from a perspective of a client device communicating with the storage system over a network, points from the data object stored on the first logical data container to a redirector file stored on a second logical data container; and
identifying a path of the redirector file stored on the second logical data container based on the backward data object handle, the redirector file including a forward data object handler, from the perspective of the client device, that point from the redirector file to the data object stored on the first logical data container.

10. The non-transitory, machine-readable medium of claim 9, wherein the identifier of the data object is a name of the data object.

11. The non-transitory, machine-readable medium of claim 9, wherein the instructions cause the storage system to extract the backward data object handle by:
identifying a portion of the identifier of the data object reserved for the backward data object handle;
reading the backward data object handle from the portion of the identifier.

12. The non-transitory, machine-readable medium of claim 9, wherein the second logical data container is a namespace logical data container that is not configured to store data objects.

13. The non-transitory, machine-readable medium of claim 9, wherein the first logical data container is a data constituent logical data container that is configured to store data objects.

14. A storage system comprising:
a processor; and
a memory in communication with the processor, the memory being configured to store instructions that, when executed by the at least one processor, cause the at least one processor to perform operations comprising:
receiving, from over a network, a request from a client device to create a file;
creating a redirector file on a first logical data container in response to receiving the request;
receiving a redirector handle resulting from the creation of the redirector file;
creating a data object of the file on a second logical data container using the redirector handle as an identifier of the data object, wherein the redirector handle is a backward data object handle, from a perspective of the client device, that points from the data object on the second logical data container to the redirector file on the first logical data container, wherein the redirector file on the first logical data container is identified by referencing the identifier of the data object stored on the second logical data container;
receiving a forward data object handle resulting from the creation of the data object on the second logical data container, wherein the forward data object handle, from the perspective of the client device, points from the redirector file to the data object; and
encapsulating the forward data object handle into the redirector file so that the redirector file includes the forward data object handle.

15. The storage system of claim 14, the operations further comprising:
responding to the request to create the file.

16. The storage system of claim 14, wherein the file can be located based on the redirector file.

17. The storage system of claim 14, wherein the identifier is a name of the data object.

18. The storage system of claim 17, wherein the name of the data object comprises the redirector handle.

19. The storage system of claim 14, wherein the first logical data container is a namespace logical data container that is configured to store redirector files.

20. The storage system of claim 14, wherein the first logical data container is a namespace logical data container that is not configured to store data objects.

21. The storage system of claim 14, wherein the redirector handle is received from a file system.
